(19) United States
(12) Patent Application Publication
(10) Pub. No.: US 2026/0005289 A1
(43) Pub. Date: Jan. 1, 2026

(54) SODIUM ELECTROCHEMICAL CELL FOR RECHARGEABLE HIGH ENERGY AND HIGH POWER BATTERIES AND METHODS OF MAKING THEREOF

(71) Applicant: NASCENT MATERIALS INC., Austin, TX (US)

(72) Inventors: Nicholas Grundish, Austin, TX (US); Mayank Sharma, Austin, TX (US); Chaitanya Sharma, Short Hills, NJ (US)

(73) Assignee: NASCENT MATERIALS INC., Austin, TX (US)

(21) Appl. No.: 19/252,082

(22) Filed: Jun. 27, 2025

Related U.S. Application Data
(60) Provisional application No. 63/666,273, filed on Jul. 1, 2024.

(51) Int. Cl. H01M 10/054; H01M 4/02; H01M 4/131; H01M 4/136; H01M 4/505; H01M 4/525; H01M 4/58; H01M 4/62; H01M 4/66; H01M 10/0565; H01M 10/0567; H01M 10/0569

(52) U.S. Cl. CPC H01M 10/054; H01M 4/131; H01M 4/136; H01M 4/505; H01M 4/525; H01M 4/5825; H01M 4/623; H01M 4/625; H01M 4/661; H01M 10/0565; H01M 10/0567; H01M 10/0569; H01M 2004/027; H01M 2004/028

(57) ABSTRACT

The present disclosure relates to a secondary sodium-based battery that can achieve energy densities comparable to state-of-the art lithium-ion batteries. The battery disclosed herein is designed to maximize energy density for a given sodium-based cathode and ease of manufacturing while minimizing cost. The battery can be constructed with any cathode that has sodium within its active material structure and a bare metal current collector to form the anode in-situ upon first charge cycle. The concepts of the present disclosure allow for ease of manufacturing as it reduces the required steps for anode processing as well as provide the energy density benefits of a sodium-metal anode without the requisite processing conditions.

### TECHNICAL FIELD

The present disclosure relates to rechargeable electrochemical cells and batteries. More particularly, the present disclosure relates to sodium electrochemical cells for secondary i.e. rechargeable high-energy and high-power batteries and methods of fabrication thereof.

### BACKGROUND

As the world's population and economy continue to expand, there is a pressing need to transition to renewable energy sources at a rate and scale that can mitigate the environmental damage caused by traditional energy sources. This transition is essential to reduce greenhouse gas emissions, improve air quality, and preserve natural resources. To achieve this transition, significant efforts have been made to promote the use of renewable energy sources, such as wind and solar energy. While these energy sources are abundant and sustainable, these forms of energy are transient and require energy generated during peak hours to be stored for off-peak hours when it is needed by a consumer. This discrepancy between energy supply and demand has generated immense interest in energy storage solutions, particularly secondary batteries as a means of storing this energy.

Secondary batteries, commonly referred to as rechargeable batteries, can efficiently store energy generated during peak hours and release it during off-peak hours when it is needed, thereby bridging the gap between energy supply and demand. This makes secondary batteries an ideal solution for addressing the intermittency of renewable energy sources. Among the various types of secondary batteries, lithium-ion batteries have emerged as a promising alternative to gasoline-powered engines for motor vehicles and other mobility applications, offering high energy and power densities.

Lithium-ion batteries have enabled a plethora of electronic devices to become portable. Through engineering and design optimization, state of the art lithium-ion batteries with a high nickel LiNiₓMn_{y}Co₂O₂ (x+y+z=1; NMC) cathode and graphite anode are able to achieve energy densities of 1000 Wh/L and specific energies of 350 Wh/kg. However, there is a growing concern over the abundance and price of lithium materials as well as other critical minerals that are needed for high-energy density lithium-ion cathode materials-namely nickel and cobalt in NMC. Beyond the cost and abundance of these materials causing the price of high energy density lithium-ion batteries to fluctuate greatly with market conditions, the ethical and geopolitical considerations over the supply-chain of nickel and cobalt have raised questions in recent years as to the true sustainability of being able to produce such batteries without a tremendous effort towards implementing a recycling ecosystem for these materials.

Sodium-based secondary batteries provide an alternative to lithium-based chemistries, offering potential cost advantages and improved material abundance. However, there are numerous differences in the physical properties of sodium materials that hinder their viability as a drop-in replacement for lithium-ion. The combination of the higher atomic weight of sodium coupled with lower operating voltage that is intrinsic to sodium materials leads to a disproportionately lower energy density for most sodium-based secondary battery chemistries relative to their lithium counterparts, even when considering a sodium metal anode which would bring additional manufacturing difficulties beyond those for traditional secondary battery manufacturing owing to the reactivity of metallic sodium. Other nuances related to the crystalline structure of sodium battery cathode materials have limited their commercial success, although ongoing research and development on these materials has led to a few relevant options for certain applications.

To address these challenges, there is a need to develop alternative high-energy density cathode materials that minimize or eliminate dependence on critical minerals like nickel and cobalt. Additionally, implementing a recycling ecosystem for these materials can help reduce the reliance on primary sources of these minerals, thereby reducing the environmental and social impacts of their mining and processing. Moreover, it would be advantageous to industry and commerce to provide means and methods to achieve higher cell-level energy density as well as to improve cost-efficiency through the use of sodium-based battery cells. The present disclosure, thus, intends to overcome the drawbacks and shortcomings discussed above.

### SUMMARY

An object of the present disclosure is to provide sodium electrochemical cells suitable for use in secondary batteries (i.e. rechargeable batteries) that exhibit both high-energy and high-power characteristics.

Another object of the present disclosure is to provide a rechargeable high-energy and high-power batteries comprising an in-situ formed sodium metal anode. Such battery can be constructed with any cathode that has sodium within its active material structure and a bare metal current collector to form the anode in-situ upon first charge cycle. The bare metal current collector including, for example, aluminium, copper or alloys thereof.

Another object of the present disclosure is to provide a sodium-based anode-less rechargeable high-energy and high-power batteries.

Another object of the present disclosure is to provide a rechargeable battery that is designed to maximize energy density for a given sodium-based cathode and ease of manufacturing while minimizing cost.

Another object of the present disclosure is to provide a rechargeable battery that exhibits comparable energy storage properties to a current lithium-ion battery but does not cost nearly as much as a lithium-ion battery. The cost-effective implementation of the battery disclosed herein will positively impact on a wide range of battery-powered products.

Another object of the present disclosure is to provide a “anode-free” sodium battery that can be assembled with high-energy sodium cathodes that do not contain any nickel or cobalt, which gives them a much lower cost relative to the same state-of-the-art sodium batteries.

One aspect of the present disclosure relates to a secondary sodium battery that is designed to maximize energy density and specific energy for any given sodium cathode chemistry. For certain embodiments, the energy density of the battery can reach and exceed that of state-of-the-art lithium-ion batteries with a high-nickel NMC cathode. The battery of the present disclosure is assembled without an anode composite deposited on the anode current collector such that it can be described as an “anode-less” battery upon assembly. During the first charge cycle, a layer of metallic sodium is deposited to form the anode “in-situ”. Several strategies to achieve this concept successfully for numerous cycles are presented. The mechanism of the present disclosure is based on an electrochemical reaction, which is similar to the normal first charge cycle of a traditional rechargeable battery. During this process, the active alkali-ion, specifically sodium as per the current disclosure, is removed from the cathode active material and transferred through the electrolyte. The sodium ions then migrate to the anode side current collector, where they are deposited as sodium metal. This electrochemical reaction is crucial for the operation of the battery, as it allows for the storage and release of electrical energy. The electrochemical reaction involved in the present disclosure is a well-established process in the field of rechargeable batteries, and the present disclosure builds upon this knowledge to provide a novel and innovative approach to sodium-based batteries.

One aspect of the present disclosure relates to non-aqueous liquid electrolytes that facilitate the stable deposition and cycling of a layer of sodium metal on an anode current collector which then serves as the anode upon extended cycling and are capable of supporting a high voltage window of the battery cell.

One aspect of the present disclosure relates to current collector material(s) supporting electrochemical deposition of sodium and preferably an essentially smooth, dendrite-free and/or preferably well-adhering electrochemical deposition of sodium. The electrochemical deposition of sodium is a practical requirement for an effective implementation of the present disclosure. The suitable current collector is comprised of aluminium or some aluminium-based alloy or copper or some copper-based alloy. In some examples, the anodic current collector substrate is selected from copper or aluminium or alloys thereof. In some examples, the cathodic current collector substrate is selected from copper or aluminium or alloys thereof.

One aspect of the present disclosure relates to a sodium electrochemical cell for rechargeable high-energy and high-power batteries comprising: a cathode current collector; a cathode electrode composite; a separator; a non-aqueous electrolyte composition that fills the cell; and an anode current collector.

One aspect of the present disclosure relates to a sodium electrochemical cell for rechargeable high-energy and high-power batteries comprising: a cathode current collector; a cathode electrode composite; a gel, gel-polymer, gel-ceramic, or gel-polymer-ceramic electrolyte(s); a non-aqueous electrolyte composition that fills the cell; and an anode current collector.

One aspect of the present disclosure relates to a method of manufacturing an electrochemical cell, comprising: preparing a cathode active materials; combining the cathode active materials with their respective binders and conductive agents; transforming the mixture into a cathode slurry; applying the cathode slurry on a cathode current collector; slitting and stamping a cathode electrode and anode current collector into specific shape and size; stacking one on top of another with a layer of separator placed in between each of the cathode electrode and anode current collector to form an assembled stack; inserting the assembled stack into a housing; introducing a non-aqueous electrolyte into the housing.

In some examples, the anode current collector comprises an in-situ formed sodium metal anode.

In some examples, the cathode electrode composite, not being limited to, may comprise 40-100 wt % active material, 0-60 wt % conductive additives and 0-10 wt % binders. Conductive additives are usually carbon-based materials that improve the electrical conductivity of the cathode electrode. Examples of conductive additives, not being limited to, may include carbon black, acetylene black, Denka black, Ketjen black, SuperP, carbon nanotubes, and graphene or the like or some other types of electronically conductive carbon, or a combination thereof. Binders are materials that hold the active material and conductive additive together in the cathode electrode and aid in binding the composite electrode to the metal foil current collector. Examples of binders, not being limited to, may include polyvinylidene fluoride (PVDF), Carboxymethyl Cellulose (CMC), styrene-butadiene rubber (SBR), or a combination thereof. It is to be understood that the sum of the weights of the active material, conductive additive, and binder must equal 100 wt %. This ensures that the cathode electrode composite is properly balanced and has the desired properties.

In some examples, the cathode electrode active material, not being limited to, may include Na[NiₓFe_{y}Mn_{z}]O₂ (x+y+z=1), Na₃V₂(PO₄)₃, Na₃V₂(PO₄)₂F₃, NaₓFe[Fe(CN)₆](1−y)·□(y)·nH₂O, and NaₓMn[Fe(CN)₆](1−y)·□(y)·nH₂O. Na[NiₓFe_{y}Mn_{z}]O₂ is a sodium-based material with nickel, iron, and manganese ions in the structure, where the specific ratio of these ions can be adjusted by altering the values of x, y, and z, as long as they add up to 1.

In some examples that incorporate a sacrificial sodium additive to the cathode composite, the sacrificial sodium additive is added to the cathode electrode composite as a fourth component, and the composite composition ranges are adjusted accordingly. In such examples, the cathode electrode composite composition, not being limited to, may comprise 40-99.9 wt % active material, 0-60 wt % conductive additives, 0-10 wt % sacrificial sodium additives, and 0-10 wt % binders. It is to be understood that the sum of the weights of the active material, conductive additive, sacrificial sodium additive and binder must equal 100 wt %. This ensures that the cathode electrode composite is properly balanced and has the desired properties. The sacrificial sodium additive intends to improve the electrochemical performance of the battery by providing additional sodium ions during the electrochemical reaction and improving the stability of the cathode electrode, which can enhance the capacity and cycle life of the battery.

In some examples that include a sacrificial sodium additive to the cathode composite, the sacrificial sodium additives, not being limited to, may include NaN₃, Na₃N, Na₃P, Na₂CO₃, NaNO₂, Na₂NiO₂, Sodium citrate, ethylenediaminetetraacetic acid tetrasodium salt (EDTA-4Na), or a combination thereof. The sacrificial sodium additive is intended to enhance the performance of the cathode electrode by providing additional sodium ions during the electrochemical reaction and improving the stability of the cathode electrode.

In some examples, the present disclosure provides a secondary sodium battery that is assembled without an anode electrode composite or any anode active material on the anode current collector during manufacturing and assembly such that the cell can be considered “anode-less” upon construction. However, upon the first charge cycle, a layer of sodium metal is deposited on the anode current collector which then serves as the anode upon extended cycling. Constructing an anode-less sodium battery of this nature with an optimized sodium cathode material can yield an energy density of up to 1000 Wh/L and a specific energy of up to 350 Wh/kg.

In some examples, the present disclosure provides a secondary sodium battery that is designed to maximize energy density and specific energy, wherein the cell designs when used with a proper cell formation and ageing process provide a dense initial film of sodium metal on the first charge which eventually serve as the anode of the cell and circumvent the problems associated with an anode-free design.

In some examples, the present disclosure provides a secondary sodium battery e.g. the hybrid concept with a coated separator which provides a physical ceramic barrier that can block the sodium dendrites, if they do form, from reaching the cathode and internally short circuiting the cell.

In some examples, the present disclosure provides a secondary sodium battery including a sacrificial sodium source such that the initial layer of sodium can be formed and the cell is still “balanced” in terms of operational sodium that is used during charge/discharge cycling.

In some examples, the electrochemical cell further comprises a non-aqueous catholyte to promote Na⁺-ion transport within the cathode electrode composite and from the cathode electrode composite to the gel, gel-polymer, gel-ceramic, or gel-polymer-ceramic electrolyte(s).

In some examples, the present disclosure provides methods of fabrication of sodium electrochemical cells for secondary i.e. rechargeable high-energy and high-power batteries.

In some examples, the present disclosure provides a novel approach to the formation procedure of sodium-based batteries, which involves the implementation of a specialized formation first-charge cycle protocol. The specialized formation first-charge cycle protocol promotes dense plating of sodium and enhances the overall performance and lifespan of the battery and thus is a unique aspect of the present disclosure. The specialized formation first-charge cycle protocol includes a “ramping” charge rate with resting steps after each charge state. For example, the charge rate may start at C/500 for 3 hours, followed by a 1-hour rest period. The charge rate may then increase to C/100 for 3 hours, followed by another 1-hour rest period. This process may continue until the nominal charge cutoff voltage is reached for the first charge cycle. The description and figures of this invention demonstrate the effectiveness of this formation protocol in promoting dense plating of sodium, which can enhance the overall performance and lifespan of the battery. This innovative approach to battery formation is a significant advancement in the field of sodium-based batteries and has the potential to improve the performance and reliability of these batteries in various applications.

### BRIEF DESCRIPTION OF THE DRAWINGS

Various aspects, as well as embodiments or examples of the present disclosure, are better understood by referring to the following detailed description. To better understand the disclosure, the detailed description should be read in conjunction with the drawings.

FIG. 1 illustrates a traditional secondary sodium-ion or lithium-ion battery with an anode composite deposited onto the anode current collector during manufacturing. The whole cell is filled with an ionically conductive non-aqueous liquid electrolyte solution.

FIG. 2A illustrates a schematic of as-assembled sodium-based anode-less battery with a traditional separator and non-aqueous liquid electrolyte in accordance with an example of the present disclosure.

FIG. 2B illustrates a schematic of sodium-based anode-less battery after the first charge cycle in which a sodium metal anode has been plated “in-situ” onto the anode current collector during the first charge cycle with sodium-ions from the cathode material in accordance with an example of the present disclosure.

FIG. 3A illustrates a schematic of as-assembled sodium-based anode-less battery with a coated separator to stabilize the anode interface and a non-aqueous liquid electrolyte in accordance with an example of the present disclosure.

FIG. 3B illustrates a schematic of sodium-based anode-less battery after the first charge cycle in which a sodium metal anode has been plated “in-situ” onto the anode current collector during the first charge cycle with sodium-ions from the cathode material in accordance with an example of the present disclosure.

FIG. 4A illustrates a schematic of as-assembled sodium-based anode-less battery with a traditional separator, a non-aqueous liquid electrolyte, and a treated anode current collector to facilitate dense plating of sodium metal on the first charge cycle in accordance with an example of the present disclosure.

FIG. 4B illustrates a schematic of sodium-based anode-less battery after the first charge cycle in which a sodium metal anode has been plated “in-situ” onto the anode current collector during the first charge cycle with sodium-ions from the cathode material in accordance with an example of the present disclosure.

FIG. 5A illustrates a schematic of as-assembled sodium-based anode-less battery with pseudo solid-state electrolyte in accordance with an example of the present disclosure.

FIG. 5B illustrates a schematic of sodium-based anode-less battery after the first charge cycle in which a sodium metal anode has been plated “in-situ” onto the anode current collector during the first charge cycle with sodium-ions from the cathode material in accordance with an example of the present disclosure.

FIG. 6A illustrates a schematic of as-assembled sodium-based anode-less battery with a traditional separator, a non-aqueous liquid electrolyte, and a sacrificial sodium additive mixed within the cathode electrode composite shown in black circles in accordance with an example of the present disclosure.

FIG. 6B illustrates a schematic of sodium-based anode-less battery after the first charge cycle in which a sodium metal anode has been plated “in-situ” onto the anode current collector during the first charge cycle with sodium-ions from the cathode material in accordance with an example of the present disclosure.

### DETAILED DESCRIPTION

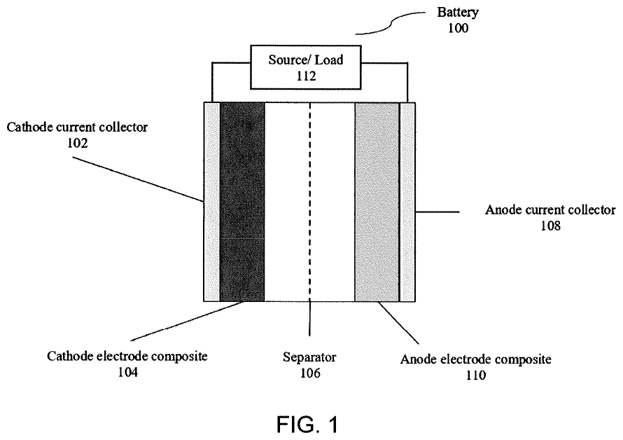

FIG. 1 is an illustration of a traditional rechargeable battery 100 comprising a source or load 112 electrically coupled to a cathode current collector 102 and an anode current collector 108. The rechargeable battery 100 further comprises a cathode electrode composite 104, a separator 106, and an anode electrode composite 110. These components are encased in a housing equipped with a positive and negative terminal that are connected to the respective current collectors including cathode current collector 102 and anode current collector 108 for consumer use. The battery 100 is filled with a non-aqueous liquid electrolyte that facilitates ionic conduction throughout the cell. Sodium-ion batteries operate under the same working principle as lithium-ion batteries. Therefore, as with lithium-ion batteries, sodium-ion batteries can have improved energy density if the traditional anode electrode composite 110 is replaced with sodium metal (or lithium metal in the case of lithium-ion batteries). However, the high reactivity of alkali metals leads to extreme difficulty in cell manufacturing and the operational life cycle. Manufacturing becomes difficult as the prepared metallic electrode must be handled with care as to not create surface defects and its exposure to moisture must be limited as it can succumb to parasitic reactions that cause it to become electrochemically inactive. In terms of performance, although the initial energy density of the cell is higher, its cycle life can be much poorer if the traditional liquid electrolyte with carbonate-based solvents is used owing to a chemical instability of these solvents with sodium metal. Such chemical instability causes non-uniform plating of sodium metal in a dendrite morphology upon cycling and can result in some operational sodium within the battery becoming inactive. Additionally, these sodium dendrites can continue to grow upon cycling until they have penetrated the inert separator 106 and create physical contact with the cathode composite 104, causing an internal short circuit.

A sodium battery assembled without a pre-existing layer of sodium metal would have additional challenges associated with the nucleation of sodium metal on the anode current collector 108 and ensuing dense platting of sodium metal. The nucleation of the first layer of sodium metal onto a metal current collector substrate needs to be performed very carefully, making the formation and aging procedure for these cells very meticulous. If the formation and aging of these cells are not performed properly, then the cycle life of the cells will be expected to be very short (less than 50 cycles), and the failure of the cells can be catastrophic if sodium dendrites are formed and permeate the separator 106 of the cell to cause an internal short circuit. This problem is exacerbated by the fact that sodium metal is highly reactive and forms robust dendrites that can penetrate the polymer separator, as opposed to lithium metal dendrites, which are softer and merely grow through the pores of the separator 106. Lithium metal dendrites can—be circumvented by the use of a tortuous separator. However, such a workaround is not applicable to sodium metal owing to the sharp and dense dendrite morphology that sodium metal dendrites adopt.

Disclosed hereafter are several examples of cell designs that can enable the “anode-free” sodium battery of high energy density.

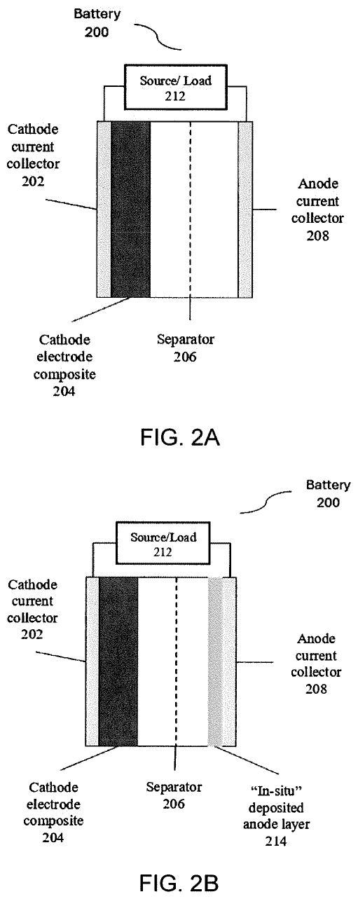

FIG. 2A illustrates a schematic representation of an “anode-free” sodium cell according to an embodiment of the present disclosure. The “anode-free” cell structurally resembles to a traditional sodium-ion battery 100, but in place of the anode coated onto a current collector, there is simply the anode current collector 208 arranged to receive sodium metal during operation. A separator 206 is positioned between a cathode electrode composite 204 and an anode current collector 208 to prevent electrical shorting while allowing ionic transport. The non-aqueous liquid electrolyte for this cell design requires a specialized composition or additives so that sodium metal is densely platted on the first charge cycle and the ensuing solid-electrolyte interphase (SEI) is dense and does not crack. Such dense SEI layer is crucial, as it helps prevent the continuous degradation of the non-aqueous liquid electrolyte during subsequent charge and discharge cycles.

FIG. 2B illustrates a schematic of sodium-based anode-less battery 200 after the completion of the first charge cycle, according to another embodiment of the present disclosure. During first charge cycle with sodium-ions from the cathode material, a sodium metal anode has been plated “in-situ” 214 onto the anode current collector 208. The sodium-ions required for this plating originates from the cathode material, which releases them into the electrolyte during charging. As a result, the anode is formed directly on the current collector during operation, thereby eliminating the need for a pre-existing anode electrode and simplifying the battery manufacturing process. This in-situ formation of the anode and the development of a stable SEI layer contribute to improved life cycle and performance of the anode-less sodium battery 200.

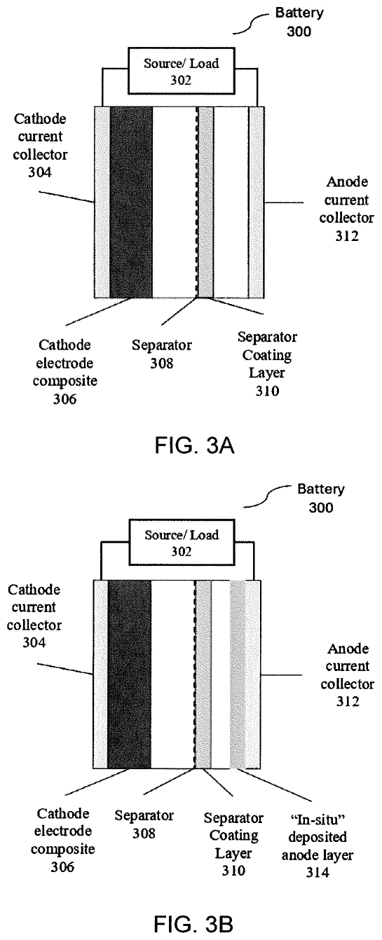

FIG. 3A illustrates a hybrid cell design that consists of a commercial rechargeable battery separator that has been coated with a ceramic polymer composite in accordance with an example of the present disclosure. The ceramic polymer composite that is used to coat the separator 308 in this cell design can be formulated using either a sodium-ion conducting ceramic or an inert ceramic material. In addition to the coated separator 308, this hybrid concept cell also uses a non-aqueous liquid electrolyte similar to the cell design shown in FIG. 2 that is compatible with sodium-metal. In addition to helping in regulate the current distribution at the anode current collector-coated separator interface and after the first cycle the anode-coated separator interface, the separator coating also provides a physical barrier in the case that sodium dendrites are formed that prevent the internal short circuiting of the cell. It should be noted that the separator 308 can be coated on one or both sides thereof, but in the case of a single-sided coated separator, the coated side is preferably oriented towards the anode to maximize the protective effect and to facilitate optimal ionic transport.

FIG. 3B illustrates a schematic of sodium-based anode-less battery 300 after the first charge cycle in accordance with an example of the present disclosure. During the first charge cycle with sodium-ions from the cathode material in which a sodium metal anode has been plated “in-situ” 314 onto the anode current collector 312. The sodium ions required for this plating are sourced from the cathode material, which releases them into the electrolyte during charging. As a result, the anode is formed directly on the current collector during the first charge cycle, eliminating the need for a pre-existing anode electrode and simplifying the battery assembly process.

In the embodiment of FIG. 3, it is essential that the separator coating be applied before the slitting or stamping of the separator 308 pieces for cell assembly. The separator 308 is coated one or both sides thereof. The composition of the separator coating is crucial and can be tailored to include a Na-ion conducting ceramic or an inert solid material, such as Al₂O₃ or other simple inorganic oxide material, along with a polymer binder. The polymer binder serves a dual purpose, aiding in the densification of the coated layer and enhancing adhesion to the separator substrate. In this specific application, the coating layer should primarily consist of ceramic material, necessitating a compositional makeup of 60-100 wt % ceramic and 0-40 wt % polymer binder. This formulation ensures that the separator coating provides the required structural integrity, ionic conductivity, and adhesion properties essential for the efficient and reliable operation of the battery cell.

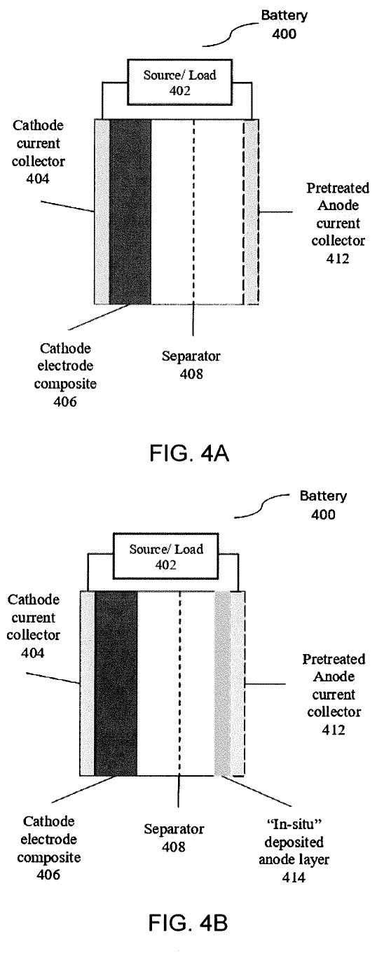

FIG. 4A illustrates a schematic of an as-assembled sodium-based anode-less battery 400 according to an embodiment of the present disclosure. The battery 400 comprises a traditional separator 408, a non-aqueous liquid electrolyte, and a pretreated anode current collector 412 to facilitate dense plating of sodium metal on the first charge cycle. In some instances, a treated metal foil can be used as the pretreated anode current collector 412, as illustrated in FIG. 4, to facilitate dense nucleation of sodium metal upon first charge of the cell. The treated metal foil includes, for example, carbon-coated aluminium foil. The selection and treatment of the metal foil are critical, as the platting morphology of the sodium metal is heavily dependent on the nucleation characteristics of the sodium metal itself, therefore treating the metal foil anode current collector can aid to regulate the current density experienced at each sodium metal grain nucleation site and enable dense grains to form, thus resulting in overall dense sodium plating at higher states of charge. Moreover, during the discharge, this pre-treated current collector 412 can also aid in allowing the sodium metal anode to strip in such a way that the dense nucleates remain at full depth of discharge and enable a low overpotential upon repeated charge/discharge cycling of the cell.

FIG. 4B illustrates a schematic of sodium-based anode-less battery 400 after the first charge cycle in accordance with an example of the present disclosure. During the first charge cycle with sodium-ions from the cathode material, a sodium metal anode has been plated “in-situ” 414 onto the anode current collector 412. The sodium ions necessary for this plating are sourced from the cathode material, which releases them into the electrolyte during charging. As a result, the anode is formed directly on the current collector during operation, eliminating the need for a pre-existing anode electrode and simplifying the battery assembly process.

In the embodiment depicted in FIG. 4, it is essential that the anode current collector 412 undergoes pretreatment before being stamped for cell stacking and assembly. This essential step is crucial for enhancing the performance of the battery 400 and ensuring its longevity. The pretreatment methods may include various techniques such as etching, polishing, or the application of a surface coating, all designed to facilitate the dense nucleation and growth of sodium metal during the first charge cycle. Each of these techniques is designed to optimize the surface characteristics of the current collector, thereby facilitating dense nucleation and uniform growth of sodium metal during the first charge cycle. By optimizing the pretreatment process, the battery 400 can achieve improved efficiency and cycling stability.

The surface coatings that can be applied in this embodiment include a single layer of graphene or a silver-carbon composite layer. Graphene is a highly conductive and structurally robust material, making it an ideal candidate for this application. It can promote the uniform growth of sodium metal and enhance the overall performance of the battery. On the other hand, the silver-carbon composite layer can offer excellent electrochemical properties, further improving the stability and efficiency of the anode current collector 412. By carefully selecting and applying these surface coatings, the battery 400 can achieve optimal performance, reliability, and longevity. By integrating these pretreatment and coating strategies, the sodium-based anode-less battery 400 of the present disclosure achieves superior plating morphology, reduced overpotential, and enhanced cycling stability, making it well-suited for a wide range of energy storage applications.

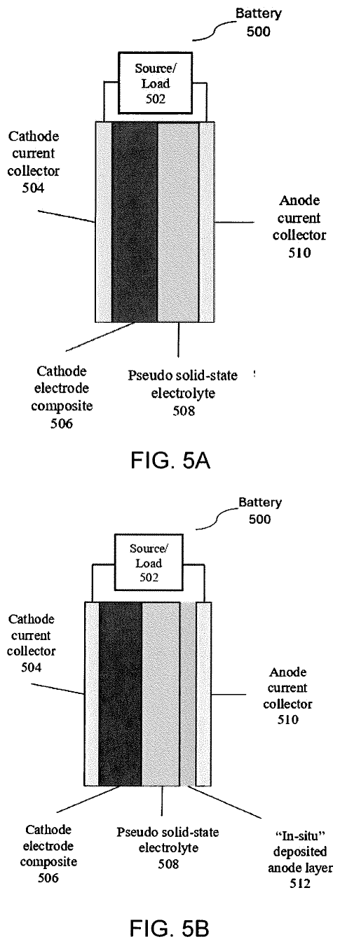

FIG. 5A illustrates a schematic representation of an as-assembled sodium-based anode-less battery 500 incorporating a non-aqueous or pseudo solid-state electrolyte 508 in accordance with an example of the present disclosure. Similar to the hybrid design as illustrated in FIG. 3, a pseudo-solid-state cell with a gel, gel-polymer, gel-ceramic, or gel-polymer-ceramic electrolyte(s) enables an “anode-free” sodium battery 500 is illustrated in FIG. 5. Such a cell design offers the benefits of an all-solid-state cell design without the difficulties that are normally associated with a traditional true all-solid-state battery-primarily the manufacturing and deployment of a heavily ceramic based solid-state electrolyte. Additionally, the gel-based approach can be used to maintain the cathode electrode design employed in rechargeable batteries, as some solid-state battery concepts require that solid electrolytes be added to the cathode composite matrix for ion diffusion through the cathode.

FIG. 5B illustrates a schematic of sodium-based anode-less battery 500 following the first charge cycle, where a sodium metal anode has been plated “in-situ” 512 onto the anode current collector 510. This plating process takes place during the first charge cycle, utilizing sodium-ions sourced from the cathode material in accordance with an example of the present disclosure.

The embodiment depicted in FIG. 5 of the present disclosure utilizes a polymer or gel-polymer electrolyte, although it is to be understood that a non-aqueous liquid electrolyte can still be employed on the cathode side. This decision is based on the absence of any solid-electrolyte component being integrated into the cathode composite 506, necessitating a means of ionic transport within the system. In certain scenarios, a polymer scaffold can serve as the medium for absorbing the non-aqueous liquid electrolyte, allowing for effective ionic transport. In such cases, the liquid component can align with those used in the other embodiments. Alternatively, the polymer or gel electrolyte may consist of a conventional Na-conducting salt, such as NaTFSI, NAPF₆, or NaFSI, solvated within a polymer matrix like polyethylene (oxide) (PEO) or polyethylene glycol (PEG), which are widely used for this purpose. Furthermore, the electrolyte may be plasticized using a plasticizing agent like succinonitrile (SN) to enhance its performance and flexibility within the system. This approach ensures efficient ionic transport and stability within the battery system, contributing to its overall functionality and longevity.

Further, in the embodiment illustrated in FIG. 5 of the present disclosure, the manufacturing process for the battery cell 500 may differ significantly depending on the specific polymer or gel-polymer electrolyte used. However, it is to be understood that the stamping or slitting process typically carried out on a battery separator will instead be performed on the polymer electrolyte membrane. This modification allows efficient integration of the polymer electrolyte into the battery cell 500.

The remaining steps in the manufacturing process may remain largely unchanged, however it is worth noting that the amount of non-aqueous liquid electrolyte required during cell filling will be reduced. This reduction has occurred because only the pores of the cathode composite 506 need to be filled with electrolyte, as the polymer electrolyte membrane itself provides a solid means of ionic transport. By optimizing the amount of non-aqueous liquid electrolyte used, the manufacturing process can be streamlined, reducing waste, and improving the overall efficiency of the battery cell production.

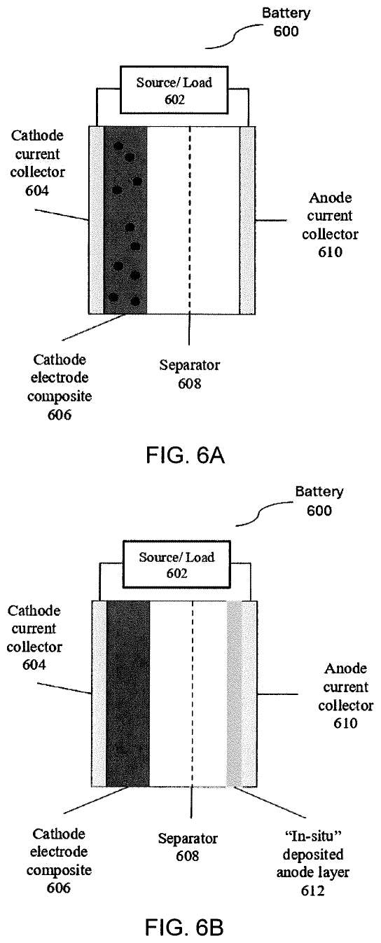

FIG. 6A illustrates a schematic representation of as-assembled sodium-based anode-less battery 600 with a traditional separator 608, a non-aqueous liquid electrolyte. The cathode electrode composite 606, illustrated with black circles, incorporates a sacrificial sodium additive in accordance with an example of the present disclosure. This cell design enables an “anode-free” sodium-ion battery 600 incorporating a cathode electrode composite 606 with an additional sacrificial sodium component. During the initial charging process this sacrificial sodium component decomposes at low-voltages releasing sodium-ions that contributes to the forming of a first dense layer of sodium metal on the anode current collector 610 This approach allows employing “anode-free” sodium-ion battery 600 with minimal overpotential and a much higher first-cycle efficiency. The sodium present in the cathode's active material is preserved, ensuring it serves as the primary operational sodium source for the battery 600.

FIG. 6B illustrates a schematic of sodium-based anode-less battery 600 following the first charge cycle in which a sodium metal anode has been plated “in-situ” 612 onto the anode current collector 610 during the first charge cycle with sodium-ions from the cathode material in accordance with an example of the present disclosure. This process, as shown in FIG. 6B, highlights the dynamic transformation of the battery 600 structure, where the anode is generated in place during the first charge, aligning with the design principles outlined in the present disclosure.

As disclosed above, the embodiments of FIGS. 2, 3, 4, and 6 utilize a non-aqueous liquid electrolyte that is compatible with sodium metal. The non-aqueous liquid electrolyte compositions used in these embodiments are specifically designed to facilitate the electrochemical reaction and promote the stable operation of the battery. The following specific compositions are disclosed, although it is understood that other compositions may also be suitable.

In one example, the first non-aqueous liquid electrolyte composition is a mixture of NaFSI, DME, and TTE in a molar ratio of 1:2:3. This composition has been shown to provide good electrochemical performance and stability with sodium metal.

In one example, the second non-aqueous liquid electrolyte composition is similar to the first, but includes the addition of NaNO₃ and FEC. The NaNO₃ is added to improve the oxidative stability of the electrolyte, while the FEC is added to improve the wettability of the electrode surfaces. The total weight percentage of NaNO₃ and FEC in this composition is 3.5%.

In one example, the third non-aqueous liquid electrolyte composition is a 1M solution of NaPF₆ in EMC and FEC in a volume ratio of 9:1. This composition is further enhanced by the addition of 1 wt % NaDFOB, which acts as a film-forming additive to improve the stability of the electrode-electrolyte interface.

It is important to note that these specific compositions are not intended to be limiting, and other non-aqueous liquid electrolyte compositions that are compatible with sodium metal may also be used in the present disclosure. The key requirement is that the electrolyte be able to facilitate the electrochemical reaction and promote stable operation of the battery.

To explain the fabrication of the battery in accordance with the present disclosure, the initial stage of battery assembly involves preparing the cathode active materials, which are then combined with their respective binders and conductive agents. This mixture is transformed into cathode slurry by adding a suitable solvent to the powder mixes. The specific proportions of these components significantly influence the characteristics of the slurry, which is a critical factor in determining the overall performance of the battery. Among the various characteristics that the slurry needs to achieve, solid % loading and viscosity are particularly important, as they have a direct impact on the subsequent coating and drying process.

Solid % loading refers to the ratio of solid material to the total volume of the slurry, which is a crucial factor in determining the thickness of the coating and the amount of active material present in the final electrode. A higher solid % loading can lead to thicker coating and a higher active material content, but it can also result in a more challenging coating process due to the increased viscosity.

Viscosity, on the other hand, is a measure of the slurry's resistance to flow, which is a critical factor in determining the ease and uniformity of the coating process. A lower viscosity can result in a more uniform coating, but it can also lead to a lower solid % loading, which can impact the overall performance of the battery. Therefore, achieving the optimal balance between solid % loading and viscosity is critical for ensuring a successful coating and drying process, which ultimately determines the quality of the final electrode and the overall performance of the battery.

Traditionally, the coating and drying process is a critical step in the assembly of batteries, where the individual slurries are applied onto specific current collectors. As a next step the cathode slurry is applied to a cathode current collector. During this process, only a portion of the current collector is coated, while the remaining areas are intentionally left uncoated. The primary parameter to be targeted is the thickness of the coating, which directly impacts the performance of the battery.

Initially, the slurries are wet due to the presence of solvents. However, they are then dried out through a series of ovens, converting them into a dry coating over the current collectors. During the drying process, the solvent evaporates, leaving behind voids that can be further compacted through a calendaring process. This process compacts the dry coated material to a target thickness and porosity, resulting in the formation of the electrodes.

An emerging technology in the industry is dry-electrode processing, which eliminates the need for solvents such as n-methyl-2-pyrrolidone. This process utilizes alternative binders that do not require solvents for processing, thereby preventing the detrimental effects and cumbersome use of traditional solvents. It is to be understood that all the disclosed embodiments of the present disclosure are compatible with this dry-electrode process, providing a more environmentally friendly and efficient approach to battery assembly. This innovative process offers several advantages over traditional methods, including reduced processing time, lower material waste, and improved safety due to the elimination of hazardous solvents.

Following the coating and drying process, the electrodes undergo a series of additional steps to prepare them for assembly into the final battery cell. The electrodes are first slit and stamped into their specific shapes and sizes, which are determined by the form factor and dimensions of the cell they will be a part of. During this stamping process, the uncoated areas of the electrodes are cut to form tabs at the head of the coated portion. These tabs serve as the pathway for electrons to travel, allowing for the flow of electrical current from the electrodes of the cell to an external device.

After stamping, the electrodes are subjected to a specific vacuum drying process, which eliminates any trapped moisture from the micropores within the electrodes. This step is crucial for ensuring the long-term stability and performance of the battery cell.

Once the vacuum drying process is complete, the electrodes are then stacked one on top of another, with a layer of separator placed in between each electrode to prevent any physical contact between the cathode and anode. This stacked design ensures that the electrodes are properly spaced and insulated from each other, preventing any short circuits or other issues that could negatively impact the performance of the battery cell.

The thickness of the stack is determined by the thickness of the cell it will be a part of, with each separator-anode-separator-cathode sequence adding to the overall thickness of the stack. This stacked design provides a highly efficient and effective means of assembling battery cells, ensuring that they are properly constructed and optimized for their intended use.

After the electrodes are stacked with separators in between, the assembled stack can be housed in different configurations to form the final battery cell, for example in a housing. One option is to enclose the stack within a polymer-coated aluminum ‘bag’ to create a pouch cell, providing a flexible and lightweight design. Alternatively, the stack can be placed in a hard can, typically made of aluminum, along with a lid, also usually aluminum, to form a hard can prismatic cell. In both cases, the stack is carefully inserted into its housing, and the individual tabs are welded together, a process commonly performed with ultrasonic welding. These welded tabs serve as the connection points for the cell's electrical terminals.

In a pouch cell configuration, the tabs are utilized within the pouch structure to facilitate the electrical connections. On the other hand, in a hard can prismatic configuration, the tabs are welded to the terminals of the lid, typically using laser welding for a secure and reliable connection. The lids of hard can prismatic cells are equipped with pressure relief discs designed to release any accumulated gases within the cell in case of malfunction, ensuring the safety and integrity of the battery. These pressure relief discs are typically rated to release gases within the range of 8-12 bar, 110-175 psi, or 100-160 psig, providing a controlled mechanism for managing internal pressure and safeguarding the cell from potential hazards.

The subsequent step in the battery assembly process involves electrolyte filling, a critical stage where the electrolyte is introduced into the cell using a precise purge-pull sequence. This methodical process begins with the creation of a vacuum within the cell, allowing the electrolyte to be dispensed and drawn into the micropores of the electrodes, effectively saturating the cell. Subsequently, the vacuum is released, and a pressurized inert gas, commonly nitrogen, is introduced into the cell. This pressurized gas serves to further drive the electrolyte into the micropores, ensuring complete saturation of the cell. This sequence is repeated over multiple cycles to guarantee that all the electrolyte is thoroughly distributed within the micropores, fully wetting the cell. The electrolyte plays a crucial role as the medium through which ions transport within the cell, facilitating the electrochemical reactions necessary for the battery's operation and performance. This meticulous electrolyte filling process is essential for ensuring optimal cell functionality and efficiency.

The final process step in the battery manufacturing process is the formation step, where the cell undergoes its first charging and discharging cycle using a specific charge/discharge process. This process typically involves holding the current constant and then holding the voltage constant, with the primary objective of forming a protective layer over the anode known as the solid-electrolyte-interphase (SEI). The SEI layer is crucial for the long-term life of the cell, as it prevents further decomposition of the electrolyte and reduces the risk of short-circuits.

The charge/discharge processes are carefully designed based on the specific chemistry and form factor of the cell to ensure a robust SEI layer is formed. The formation process also initiates electrochemical reactions within the cell, activating the active materials and enabling the cell to function properly. This step is critical for the overall performance and longevity of the battery, as it sets the foundation for the cell's ability to store and release electrical energy efficiently and reliably over time. The formation process comprises a pulse charging procedure with a ramping current rate.

It is to be noted that during the formation process, chemical reactions within the battery cell generate gases as a byproduct. To ensure the safe and reliable operation of the cell, it is essential to evacuate these gases before the cell is completely sealed and prepared for use. This step is critical for preventing any potential safety hazards or performance issues that could arise from the accumulation of gases within the cell.

After the formation process and gas evacuation, the cells undergo an aging process, which typically involves storing them on shelves for several days in a hot environment, followed by additional days in a room temperature environment. This aging process allows the cells to stabilize and reach their full performance potential, ensuring that they are ready for use by the customer.

The aging process is a crucial step in the battery manufacturing process, as it enables the cell to reach its optimal performance and longevity. By allowing the cell to stabilize and mature, the aging process helps to ensure that the cell is able to deliver reliable and consistent performance over its entire lifespan.

The aforementioned concepts can be used in combination with each other to boost performance and ensure maximum safety. For example, a hybrid concept cell with a sodium-metal compatible non-aqueous liquid electrolyte and a coated separator can be used with a sacrificial sodium material that has been added into the cathode electrode matrix and a pre-treated anode current collector that enables dense platting of sodium metal.

The term “cell” used in the present disclosure refers to an electrochemical cell as a smallest, packed form of a battery. The term “battery” refers to a group of one or more of the abovesaid cells (a stack of cells, for example), unless otherwise indicated.

The above stated descriptions are merely example implementations of this application but are not intended to limit the protection scope of this application. A person with ordinary skills in the art may recognize substantially equivalent structures or substantially equivalent acts to achieve the same results in the same manner or a dissimilar manner; the exemplary embodiment should not be interpreted as limiting the disclosure to one embodiment.

While aspects of the present disclosure have been described in detail with reference to the illustrated embodiments or examples, those skilled in the art will recognize that many modifications may be made thereto without departing from the scope of the present disclosure. The present disclosure is not limited to the precise construction and compositions disclosed herein; any and all modifications, changes, and variations will become apparent from the foregoing descriptions and are within the spirit and scope of the disclosure of the claims to follow. Moreover, the present concepts expressly include any and all combinations and sub-combinations of the preceding elements and features.

The description is provided for clarification purposes and is not limited. Words and phrases are to be accorded with their ordinary, plain meaning, unless indicated otherwise.

1. A sodium electrochemical cell for rechargeable high-energy and high-power batteries comprising:
a cathode current collector;
a cathode electrode composite;
a separator;
an electrolyte composition selected from the group consisting of a non-aqueous liquid electrolyte and a gel, gel-polymer, gel-ceramic, or gel-polymer-ceramic electrolyte that fills the cell; and
an anode current collector.

2. The sodium electrochemical cell of claim 1, wherein the anode current collector comprises an in-situ formed sodium metal anode.

3. The sodium electrochemical cell of claim 1, wherein the cathode electrode composite comprising 40-100 wt % active material, 0-60 wt % conductive additives and 0-10 wt % binders.

4. The sodium electrochemical cell of claim 1, wherein the cathode electrode composite comprising 40-99.9 wt % active material, 0-60 wt % conductive additives, 0-10 wt % sacrificial sodium additives, and 0-10 wt % binders.

5. The sodium electrochemical cell of claim 3, wherein the active material at least partially comprises Na[NiₓFe_{y}Mn_{z}]O₂ (x+y+z=1), Na₃V₂(PO₄)₃, Na₃V₂(PO₄)₂F₃, NaₓFe[Fe(CN)₆](1−y)·(y)·nH₂O, and NaₓMn[Fe(CN)₆](1−y)·(y)·nH₂O.

6. The sodium electrochemical cell of claim 3, wherein conductive additives at least partially comprises carbon black, acetylene black, Denka black, Ketjen black, SuperP, carbon nanotubes, graphene or other types of electronically conductive carbon, or a combination thereof.

7. The sodium electrochemical cell of claim 3, wherein binders at least partially comprises polyvinylidene fluoride (PVDF), styrene-butadiene rubber (SBR), or a combination thereof.

8. The sodium electrochemical cell of claim 4, wherein sacrificial sodium additives at least partially comprises NaN₃, Na₃N, Na₃P, Na₂CO₃, NaNO₂, Na₂NiO₂, Sodium citrate, ethylenediaminetetraacetic acid tetrasodium salt (EDTA-4Na), or a combination thereof.

9. The sodium electrochemical cell of claim 1, wherein the non-aqueous liquid electrolyte composition comprises a mixture of NaFSI, DME, and TTE in a molar ratio of 1:2:3.

10. The sodium electrochemical cell of claim 1, wherein the non-aqueous liquid electrolyte composition comprising a mixture of NaFSI, DME, TTE, NaNO₃ and FEC including a total weight percentage of NaNO₃ and FEC being 3.5%.

11. The sodium electrochemical cell of claim 1, wherein the non-aqueous liquid electrolyte composition comprising a 1M solution of NaPF₆ in EMC and FEC in a volume ratio of 9:1 including addition of 1 wt % NaDFOB, which acts as a film-forming additive to improve the stability of the electrode-electrolyte interface.

12. The sodium electrochemical cell of claim 1, wherein the separator is coated on one or both sides thereof with a ceramic polymer composite comprising 60-100 wt % ceramic and 0-40 wt % polymer binder.

13. The sodium electrochemical cell of claim 1, wherein the anode current collector comprises a treated metal foil.

14. The sodium electrochemical cell of claim 1, wherein the electrochemical cell further comprises a non-aqueous catholyte to promote Na⁺-ion transport within the cathode electrode composite and from the cathode electrode composite to the gel, gel-polymer, gel-ceramic, or gel-polymer-ceramic electrolyte(s).

15. The sodium electrochemical cell of claim 1, wherein the non-aqueous liquid, gel, gel-polymer, gel-ceramic, or gel-polymer-ceramic electrolyte(s) are plasticized using a plasticizing agent.

16. A method of manufacturing an electrochemical cell, comprising:
preparing a cathode active materials;
combining the cathode active materials with their respective binders and conductive agents;
transforming the mixture into a cathode slurry;
applying the cathode slurry on a cathode current collector;
slitting and stamping a cathode electrode and anode current collector into specific shape and size;
stacking one on top of another with a layer of separator placed in between each of the cathode electrode and anode current collector to form an assembled stack;
inserting the assembled stack into a housing;
introducing a non-aqueous liquid electrolyte into the housing; and
performing a formation and gas evacuation process, wherein the formation process includes a pulse charging procedure with a ramping current rate to promote dense sodium plating.

17. The method of claim 16, wherein the step of transforming the cathode mixture into a slurry comprises addition of a suitable solvent to the powder mixture.

18. The method of claim 16, wherein the step of applying the cathode slurry on a cathode current collector comprises the steps of coating and drying.

19. The method of claim 16, wherein the step of introducing the electrolyte comprises a precise purge-pull sequence.

20. The method of claim 16, further comprising the step of aging process.
